(19) United States
(12) Patent Application Publication
(10) Pub. No.: US 2024/0310847 A1
(43) Pub. Date: Sep. 19, 2024

(54) AUTONOMOUS MOBILE OBJECT CONTROL METHOD

(71) Applicant: Panasonic Intellectual Property Management Co., Ltd., Osaka (JP)

(72) Inventors: YOSHIFUMI KORI, Kyoto (JP); AKIO SHIGEKANE, Osaka (JP)

(21) Appl. No.: 18/674,974

(22) Filed: May 27, 2024

Related U.S. Application Data
(63) Continuation of application No. PCT/JP2022/027505, filed on Jul. 13, 2022.

(30) Foreign Application Priority Data
Nov. 30, 2021 (JP) 2021-194358

(51) Int. Cl. G05D 1/242; G05D 107/60

(52) U.S. Cl. CPC G05D 1/2427; G05D 2107/60

(57) ABSTRACT

An autonomous mobile object control method according to the present disclosure is an autonomous mobile object control method for controlling a driving unit that causes a body to move, the autonomous mobile object control method including: a first step of determining an approach route that is a route to be followed by the autonomous mobile object to a starting point outside an elevator, and of moving the body by controlling the driving unit based on the approach route; and a second step of determining a boarding route that is a route to be followed by the autonomous mobile object from the starting point to an end point inside the elevator, and of moving the body by controlling the driving unit based on the boarding route.

### TECHNICAL FIELD

The present disclosure relates to an autonomous mobile object control method.

### BACKGROUND ART

Autonomous mobile objects such as robots that move autonomously have come to be widely used. PTL 1 discloses a robot that moves autonomously between floors of a facility by using an elevator installed in the facility. In order to enable a smooth boarding or unboarding operation, PTL 1 discloses a technique for controlling a robot to make a turn to match the orientation of the robot to that of the elevator at the time of boarding or unboarding the elevator.

### CITATION LIST

### Patent Literature

PTL 1: Unexamined Japanese Patent Publication No. 2020-187483

### SUMMARY OF THE INVENTION

However, with the technique disclosed in PTL 1, because a robot makes a turn without giving any considerations to the positional relationships between the robot and obstacles such as a wall surface near the elevator, the robot may collide with the wall surface near the elevator while the robot makes a turn.

An object of the present disclosure is to provide an autonomous mobile object control method for enabling an autonomous mobile object to move into the car of an elevator autonomously and safely.

An autonomous mobile object control method according to the present disclosure is an autonomous mobile object control method for controlling a driving unit that causes a body to move, the autonomous mobile object control method including: a first step of determining an approach route that is a route to be followed by the autonomous mobile object to a starting point outside an elevator, and of moving the body by controlling the driving unit based on the approach route; and a second step of determining a boarding route that is a route to be followed by the autonomous mobile object from the starting point to an end point inside the elevator, and of moving the body by controlling the driving unit based on the boarding route.

According to the present disclosure, the autonomous mobile object can move into the car of an elevator autonomously and safely.

### BRIEF DESCRIPTION OF THE DRAWINGS

FIG. 1 is a perspective view illustrating an exemplary external appearance of an autonomous mobile object according to an exemplary embodiment of the present disclosure.

FIG. 2A is a top view of the autonomous mobile object.

FIG. 2B is a diagram illustrating how the autonomous mobile object makes a turn.

FIG. 3 is a functional block diagram of the autonomous mobile object.

FIG. 4 is a flowchart illustrating an exemplary operation of the autonomous mobile object.

FIG. 5 is a schematic diagram illustrating an elevator and the autonomous mobile object moving in an area around elevator in a top view.

FIG. 6A is a table indicating a specific example of section information used when the autonomous mobile object moves on the floor illustrated in FIG. 5.

FIG. 6B is a table indicating a specific example of section information used when the autonomous mobile object moves on the floor illustrated in FIG. 5.

FIG. 7A is a diagram for describing a direction toward which the body makes a turn at a via point.

FIG. 7B is a diagram for describing another example of the direction toward which the body makes a turn at the via point.

FIG. 8 is a diagram for describing a method by which a target point setting unit sets a target point.

FIG. 9 is a diagram illustrating positional relationships between the autonomous mobile object and a plurality of detection points.

### DESCRIPTION OF EMBODIMENT

An exemplary embodiment of the present disclosure will be described below with reference to the drawings.

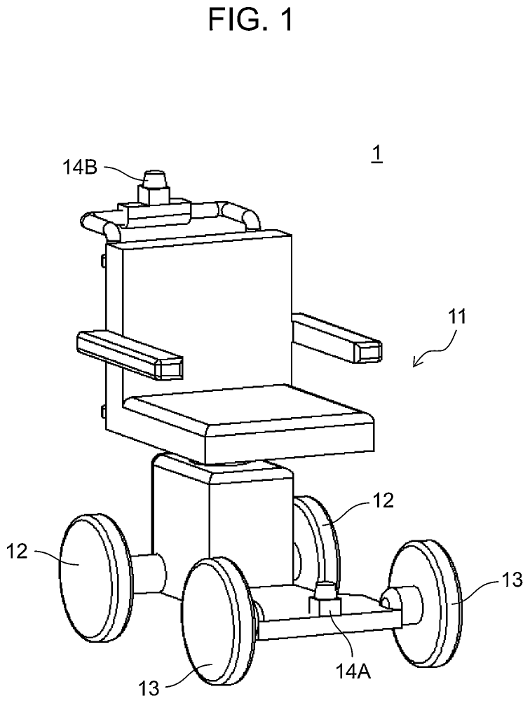

FIG. 1 is a perspective view illustrating an exemplary external appearance of autonomous mobile object 1 according to an exemplary embodiment of the present disclosure. Autonomous mobile object 1 is an autonomous mobile robot capable of autonomously moving inside a facility, for example. In the present disclosure, it is assumed that autonomous mobile object 1 is used in a facility where autonomous mobile object 1 can move to a plurality of floors using an elevator.

Autonomous mobile object 1 includes a body 11 on which a pair of driving wheels 12 and a pair of driven wheels 13 are mounted. In the present disclosure, moving autonomous mobile object 1 will be sometimes described as autonomous mobile object 1 causing body 11 to move.

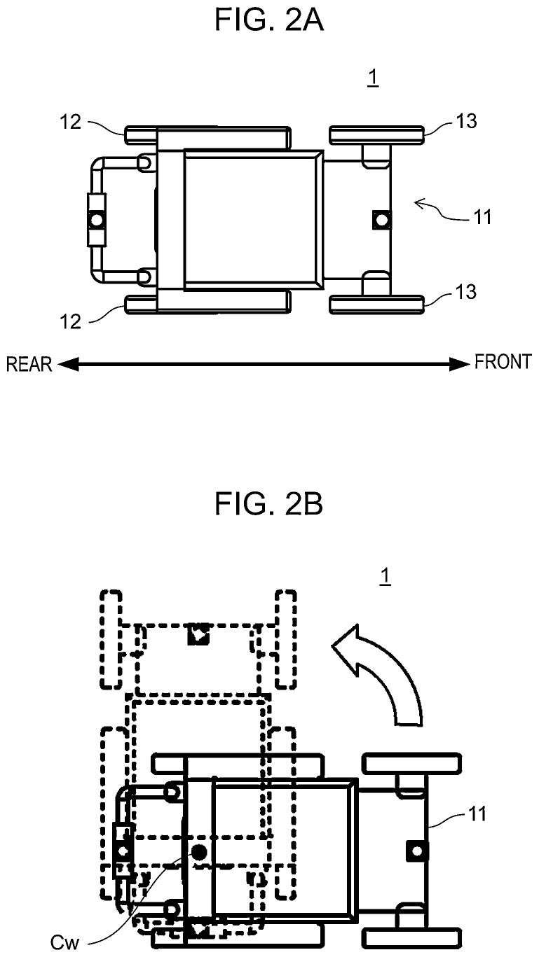

FIG. 2A is a top view of autonomous mobile object 1. Designating the side of driven wheels 13 as front and the side of driving wheels 12 as rear, autonomous mobile object 1 is capable of moving one of a forward direction or rearward direction.

Autonomous mobile object 1 can turn body 11 to adjust the orientation of body 11 by controlling the rotating direction and the speed of driving wheels 12. For example, by rotating the left and right driving wheels 12 at the same speed but in opposite directions, body 11 can make a turn about the center point between the left and right driving wheels 12. In the present disclosure, the position of the center about which body 11 is turned will be referred to as turn center Cw.

In FIG. 2B, the solid line indicates the position of body 11 before making a turn, and the dotted line indicate the position of body 11 after the turn. As illustrated, autonomous mobile object 1 has turn center Cw of body 11 at the center between driving wheels 12 that are the rear wheels. In other words, turn center Cw is offset to the rear side, from the center of the front-rear direction of body 11, as illustrated in FIG. 2B. That is to say, body 11 has a turn center eccentric toward the rear side. In the present embodiment, the turn center being eccentric means that the turn center is offset from the center of a circle circumscribing body 11 in a top view. Note that the rear part of body 11 is an example of one side according to the present disclosure. In the present exemplary embodiment, the eccentricity of turn center is as described above, but the present invention is not limited thereto. For example, the turn center may be eccentric with respect to the center of gravity of the body. In either case, autonomous mobile object 1 can move into an elevator car autonomously and safely, using a method of boarding the elevator car to be described later.

As illustrated in FIG. 1, ranging sensors 14A, 14B are mounted on body 11.

Ranging sensors 14A, 14B acquire a distance to an obstacle, a wall, or the like that are in an area around autonomous mobile object 1, at each certain angular resolution. Ranging sensor 14A is mounted on the front side of body 11, and ranging sensor 14B is mounted on the rear side of body 11. Ranging sensor 14A detects the positions and the directions of objects that are in front of body 11, and ranging sensor 14B detects the positions and the directions of objects that are in front of body 11. In the following description, ranging sensor 14A and ranging sensor 14B will be sometimes collectively referred to as ranging sensors 14.

Controller 15 is provided to the internal of body 11. One example of controller 15 is a computer including a processor such as a central processing unit (CPU) and a storage medium such as a memory.

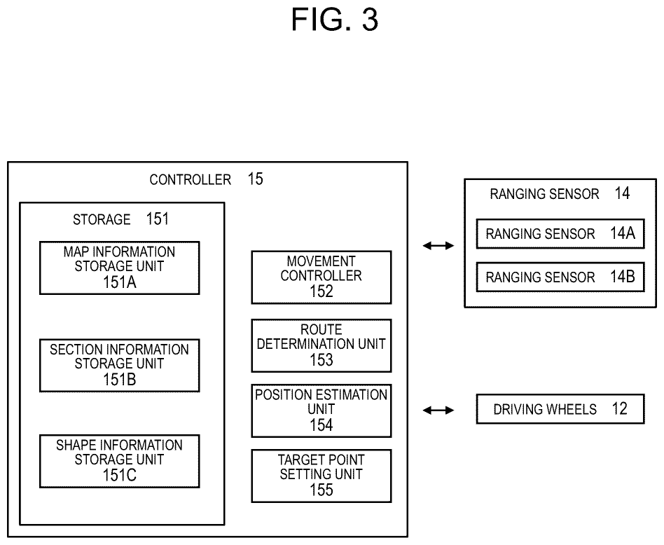

A control system of autonomous mobile object 1 will be described next. FIG. 3 is a functional block diagram of autonomous mobile object 1.

Controller 15 includes storage unit 151, movement controller 152, route determination unit 153, position estimation unit 154, and target point setting unit 155.

Storage unit 151 includes map information storage unit 151A, section information storage unit 151B, and shape information storage unit 151C.

Map information storage unit 151A stores therein map information of the area where autonomous mobile object 1 is movable. Autonomous mobile object 1 stores section information in section information storage unit 151B. Shape information storage unit 151C stores therein information about the shape of the elevator shape.

The map information is information related to a map representing an area where autonomous mobile object 1 is movable, and the areas where there are obstacles such as walls and signboards. One example of the map included in the map information is an occupancy grid map. An occupancy grid map is obtained by plotting a grid onto the floor on which autonomous mobile object 1 moves, and by assigning each cell in the grid with values indicating whether the area is an area where autonomous mobile object 1 is allowed to move, or an area corresponding to an obstacle.

Section information storage unit 151B stores therein section information indicating a section along which autonomous mobile object 1 moves. The section information includes information indicating the positions of a starting point position and an end point position of the section, and whether the end point position is inside the elevator. Note that section information storage unit 151B may store therein section information related to one section along which autonomous mobile object 1 is scheduled to move, or may store therein section information related to a plurality of sections. The section information related to a plurality of sections is stored in section information storage unit 151B in a manner associated with the order of the sections in which autonomous mobile object 1 moves.

When a plurality of pieces of section information are to be stored, the entire section information may be stored in section information storage unit 151B in advance, or section information may be input from the external via wireless communication or the like, as required, and accumulated in section information storage unit 151B. The section information will be described later in detail, using a specific example.

Shape information storage unit 151C stores therein shape information related to the shape of the elevator where autonomous mobile object 1 is to board. The shape information is information of the shape of the elevator with the door opened. The shape information will be described later in detail, using a specific example.

Movement controller 152 performs the control for moving autonomous mobile object 1. Specifically, movement controller 152 controls driving wheels 12 to move body 11 along a route generated by route determination unit 153. Note that, while movement controller 152 is causing body 11 to move along the route, movement controller 152 may also cause body 11 to avoid an obstacle based on the detection result of ranging sensor 14 within a range where body 11 does not deviate from the route.

Route determination unit 153 determines a route for causing body 11 to move from the starting point position to the end point position, on the basis of the map information and the section information, and generates route information related to the determined route.

Position estimation unit 154 estimates the position of autonomous mobile object 1 on the basis of the detection result of ranging sensor 14, the rotation speed information indicating the rotation speed of driving wheels 12, the rotation speed being output from an encoder incorporated in driving wheels 12, and the map information stored in map information storage unit 151A.

When movement controller 152 causes autonomous mobile object 1 to move into the elevator, target point setting unit 155 sets a target point for enabling body 11 to move without colliding with the wall surface where the entrance of the elevator is provided, the entrance of the elevator, or the wall surfaces inside the elevator, for example.

### Operation Example of Autonomous Mobile Object 1

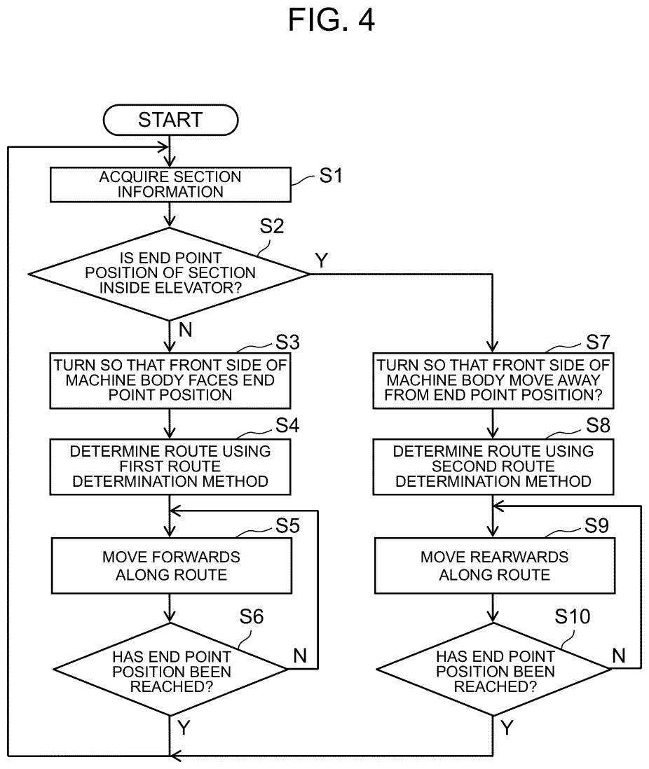

FIG. 4 is a flowchart illustrating an operation example of autonomous mobile object 1 having the configuration described above. The flowchart illustrated in FIG. 4 is executed before autonomous mobile object 1 enters a new section.

In step S1, route determination unit 153 acquires section information of the section to which autonomous mobile object 1 is about to enter, from section information storage unit 151B. As mentioned earlier, the section information includes the starting point position and the end point position of the section, and information indicating whether the end point position is inside of the elevator.

In step S2, route determination unit 153 refers to the acquired section information, and determines whether the end point position is inside of the elevator. If the end point position is not inside of the elevator (step S2: N), the process is shifted to step S3. If the end point position is inside the elevator (step S2: Y), the process is shifted to step S7.

If the end point position of the section is not inside the elevator, movement controller 152 causes body 11 to make such a turn in step S3 that front side of body 11 comes to face the end point position.

In step S4, route determination unit 153 determines a route for moving body 11 from the starting point position to the end point position designated in the section information, using a first route determination method. The first route determination method will be described later in detail.

In step S5, movement controller 152 causes body 11 to move forward by taking the route.

In step S6, movement controller 152 determines whether body 11 has reached the end point position, as a result of moving in step S5. If body 11 has reached the end point position (step S6: Y), the process is returned to step S1. If not (step S6: N), the process is returned to step S5.

When the end point position of the section is inside the elevator, movement controller 152 makes a turn in step S7 in such a manner that the front side of body 11 moves away from the end point position.

In step S8, route determination unit 153 determines a route for moving body 11 from the starting point position to the end point position designated in the section information, using a second route determination method. The second route determination method will be described later in detail.

In step S9, movement controller 152 then causes body 11 to move rearwards by taking the route.

In step S10, movement controller 152 determines whether body 11 has reached the end point position, as a result of moving in step S9. If body 11 has reached the end point position (step S10: Y), the process is returned to step S1. If not (step S6: N), the process is returned to step S9.

If it is determined in step S6 or step S10 that autonomous mobile object 1 has finished moving the entire section, the process is ended.

### Specific Example

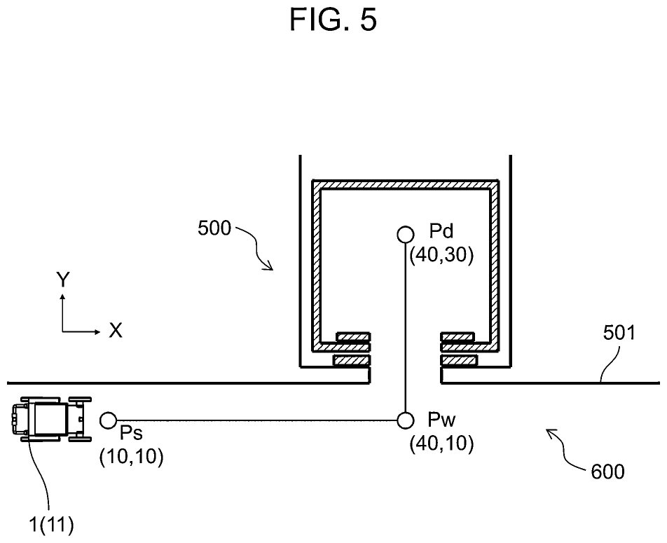

The operation of autonomous mobile object 1 described with reference to FIG. 4 will now be described using a more specific example. Described in detail below is an operation performed when autonomous mobile object 1 boards elevator 500 in a facility, by autonomously moving from departure point Ps set to a point outside elevator 500 to destination point Pd set to a point inside elevator 500 on a certain floor having an entrance to elevator 500. FIG. 5 is a schematic diagram illustrating elevator 500 and autonomous mobile object 1 moving in an area around elevator 500 in a top view.

Illustrated in FIG. 5 is an example in which departure point Ps is provided at one point in elevator hall 600 facing the entrance of elevator 500, and destination point Pd is set to a point inside elevator 500. To begin with, autonomous mobile object 1 moves from departure point Ps to the vicinity of the entrance of elevator 500 in elevator hall 600, changes the direction (makes a turn) on the spot, and then moves to destination point Pd inside elevator 500. In the following description, a point where autonomous mobile object 1 changes its direction will be referred to as via point Pw. Via point Pw is a point in elevator hall 600 and in the vicinity of the entrance of elevator 500. Via point Pw is preferably set to a position relatively close to the entrance of elevator 500. The reason for this setting will be described later. Note that departure point Ps, via point Pw, and destination point Pd are set in advance, before autonomous mobile object 1 starts moving.

For the sake of description, a two-dimensional coordinate system X-Y is set to the top view illustrated in FIG. 5. The X axis is an axis set in a direction parallel with wall surface 501 where the entrance of the elevator is provided, and the Y axis is an axis set in a direction perpendicular to wall surface 501 where the entrance of the elevator is provided. In the X-Y coordinate system illustrated in FIG. 5, the coordinates corresponding to departure point Ps are (10, 10); the coordinates corresponding to via point Pw are (40, 10); and the coordinates corresponding to destination point Pd are (40, 30).

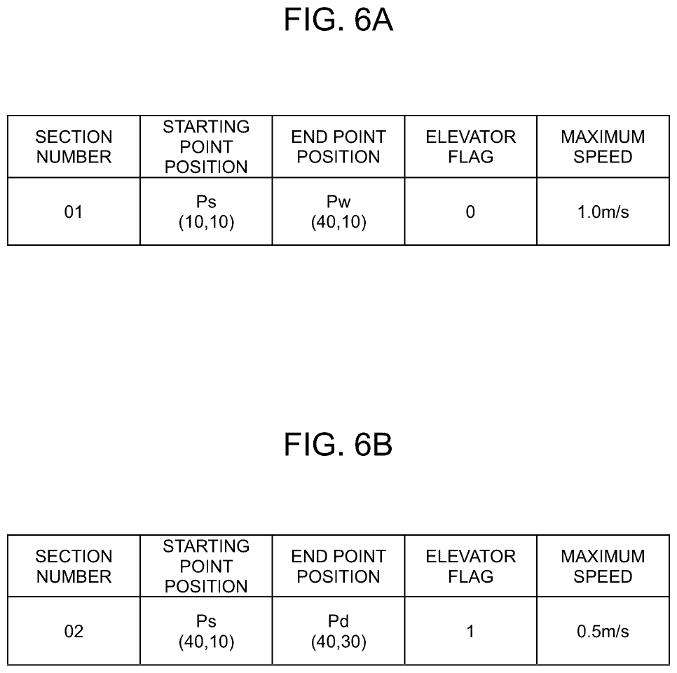

FIGS. 6A and 6B are tables indicating specific examples of the section information used when autonomous mobile object 1 moves on the floor illustrated in FIG. 5. In the example illustrated in FIGS. 6A and 6B, the section information includes a section number, a starting point position and an end point position of each section, an elevator flag, and a maximum speed.

The section number is a number given to each section. FIG. 6A indicates section information of a section assigned with section number 01, and FIG. 6B indicates section information of a section assigned with section number 02. Each piece of section information is thus stored in a manner mapped to a section number in section information storage unit 151B.

Section number 01 corresponds to the section from departure point Ps to via point Pw illustrated in FIG. 5. Section number 02 corresponds to the section from via point Pw to destination point Pd illustrated in FIG. 5. That is, the section identified by section number 01 and the section identified by section number 02 are continuous. In the following description, the section corresponding to section number 01 will be sometimes referred to as section 01, and the section corresponding to section number 02 will be sometimes referred to as section 02.

In the section information illustrated in FIGS. 6A and 6B, the starting point position indicates the starting point position of the corresponding section. The end point position indicates the end point position of the corresponding section. The starting point position of section 01 indicated in FIG. 6A corresponds to departure point Ps illustrated in FIG. 5, and is at coordinates (10, 10). The end point position of section 01 indicated in FIG. 6A and the starting point position of section 02 indicated in FIG. 6B correspond to via point Pw, and is at coordinates (40, 10). The end point position of section 02 indicated in FIG. 6B corresponds to destination point Pd, and is at coordinate (40, 30).

The elevator flag is a flag indicating whether the end point position of the corresponding section is inside the elevator, and corresponds to information indicating whether the end point position is inside the elevator, in the description above. If the end point position is inside the elevator, the elevator flag is set to “1”. If not, the elevator flag is set to “0”. In the present disclosure, the inside of the elevator means the space inside the car of the elevator. In the example indicated in FIG. 6A, because the end point position (that is, via point Pw) of section 01 is outside the elevator hall, the elevator flag is set to “0”. In the example indicated in FIG. 6B, because the end point position (that is, destination point Pd) of section 02 is inside the elevator, the elevator flag is set to “1”.

The maximum speed is the highest speed at which autonomous mobile object 1 is permitted to move in the corresponding section. There is no particular limitation in the way in which the maximum speed is set, but for the sake of safety, a lower value may be set to the maximum speed when autonomous mobile object 1 enters the elevator, or moves inside the elevator, than that when autonomous mobile object 1 moves outside the elevator. In the example indicated in FIG. 6A, the maximum speed in section 01 is set to 1.0 m/s, and in the example indicated in FIG. 6B, the maximum speed in section 02 is set to 0.5 m/s.

### Operation in Section 01 (Section from Departure Point Ps to Via Point Pw)

The operation of autonomous mobile object 1 in section 01 will be specifically described below. In autonomous mobile object 1 located at departure point Ps, route determination unit 153 (see FIG. 3) acquires section information corresponding to section 01 from section information storage unit 151B (see step S1 in FIG. 4). Section 01 is a section from departure point Ps to via point Pw, as mentioned earlier.

As indicated in FIG. 6A, section 01 has the elevator flag set to “0”. This means that the end point position (via point Pw) of section 01 is not inside elevator 500. Therefore, movement controller 152 controls driving wheels 12 to change the direction of autonomous mobile object 1 to a direction in which the front side of body 11 faces the end point position (via point Pw) (see step S3 in FIG. 4). The direction of autonomous mobile object 1 is changed about eccentric turn center Cw on the rear side of body 11, by causing movement controller 152 to drive the left and right driving wheels 12 in the opposite directions, as described earlier. As a result, the front side of body 11 faces the end point position, so that body 11 can be moved to the end point position smoothly.

When body 11 finishes changing the direction, route determination unit 153 determines the route for moving from the starting point position (departure point Ps) to the end point position (via point Pw), by using the first route determination method (see step S4 in FIG. 4). Note that, in the present disclosure, the route for moving from departure point Ps outside elevator 500 to via point Pw also outside elevator 500, that is, the route for approaching elevator 500 will be referred to as an approach route.

The first route determination method will be now described in detail. In the first route determination method, route determination unit 153 determines the approach route on the basis of the position of autonomous mobile object 1 estimated by position estimation unit 154.

Position estimation unit 154 estimates the position of position estimation unit 154 itself, on the basis of the detection result of ranging sensor 14A (see FIG. 1) provided on the front side of body 11, and on the map information stored in map information storage unit 151A (see FIG. 3). Any known method may be used as a method for position estimation unit 154 to estimate the position of position estimation unit 154 itself. Furthermore, it is also possible to improve the accuracy of the self-position estimation by using a plurality of self-position estimation methods.

A specific example will be described. Position estimation unit 154 calculates a first self-position candidate using a method of comparing the detection result of ranging sensor 14A with the map information stored in map information storage unit 151A (a method referred as map matching or the like), for example. Position estimation unit 154 also calculates a second self-position candidate based on the starting point position and the amount by which autonomous mobile object 1 has moved, the amount being calculated from the rotation speed information output from the encoder measuring the rotation speed of driving wheel 12. Position estimation unit 154 then integrates the first self-position candidate and the second self-position candidate using a Kalman filter or the like, to obtain the final estimation result of the self-position.

Route determination unit 153 determines the approach route on the basis of the self-position estimation result estimated by position estimation unit 154, the detection result of ranging sensor 14A, and the map information. Illustrated in FIG. 5 is an example of a route in which autonomous mobile object 1 moves simply linearly from departure point Ps as the starting point position to via point Pw as the end point position. However, if there is any obstacle (such as a person, a pillar, or a signboard) detected between the starting point position and the end point position by ranging sensor 14A or identified on the basis of the map information, route determination unit 153 may determine an approach route for detouring such an obstacle.

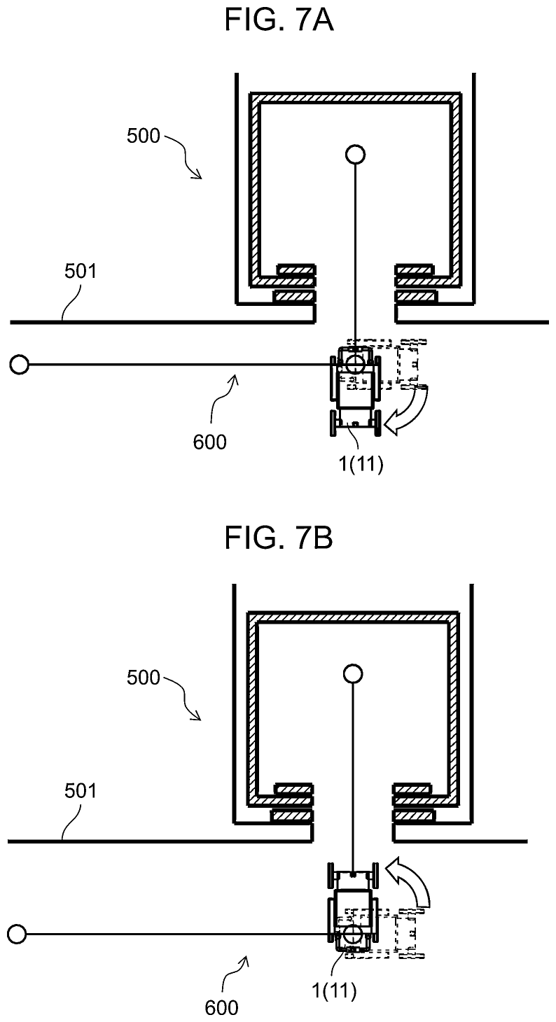

Note that, when there is no obstacle or the like between departure point Ps as the starting point position and via point Pw as the end point position, route determination unit 153 preferably determines an approach route that follows wall surface 501 nearby wall surface 501 where the entrance of elevator 500 is provided. The reason for this will be described later in relation to FIGS. 7A and 7B.

Once the approach route is determined, movement controller 152 controls driving wheels 12 so as to cause autonomous mobile object 1 to move forward, by following the approach route determined by route determination unit 153 (see step S5 in FIG. 4). Through such an operation, autonomous mobile object 1 can move from departure point Ps to via point Pw safely and autonomously.

### Operation in Section 02 (Section from Via Point Pw to Destination Point Pd)

Once autonomous mobile object 1 arrives at via point Pw, which is the end point position of section 01, route determination unit 153 determines that the movement in section 01 has completed. Autonomous mobile object 1 then acquires section information corresponding to section 02, which is the section in which autonomous mobile object 1 is to take next, from section information storage unit 151B (see step S1 in FIG. 4). The determination as to whether autonomous mobile object 1 has arrived at via point Pw, which is the end point position of section 01, can be made by determining whether the result of the self-position estimation made by position estimation unit 154 has matched the position of via point Pw.

As mentioned earlier, section 02 is a section leading from via point Pw to destination point Pd.

The elevator flag of section 02 is set to “1”, as indicated in FIG. 6B. In other words, the end point position (destination point Pd) of section 02 is inside elevator 500. Therefore, movement controller 152 controls driving wheels 12 to change the direction of autonomous mobile object 1 to a direction where the rear side of body 11 faces destination point Pd, which is inside of elevator 500 (see step S7 in FIG. 4). In this manner, the rear side of body 11 is brought facing destination point Pd.

As mentioned above, via point Pw is a point near the entrance of elevator 500 in elevator hall 600. When body 11 makes a turn to change its direction, it is necessary to determine which direction to turn so that body 11 does not collide with the wall of elevator hall 600 or the door of elevator 500.

A direction in which body 11 turns at via point Pw will now be described with reference to FIG. 7A. In FIG. 7A, the broken line indicates body 11 before making a turn, and the solid line indicates body 11 after the turn. In the example illustrated in FIG. 7A, movement controller 152 causes body 11 to turn in the clockwise direction.

The direction in which body 11 makes a turn may be determined in the manner described below, for example. At the point in time at which autonomous mobile object 1 arrives at via point Pw, body 11 is facing the same direction as the direction viewing via point Pw from departure point Ps. In the example illustrated in FIG. 7A, from the viewpoint of body 11 facing this direction, the entrance of elevator 500 is on the left side.

Body 11 has eccentric turn center Cw on the rear side of body 11, as illustrated in FIG. 2B. Therefore, when body 11 makes a turn, the front end of body 11 delineates an arc centered about turn center Cw. As described above, because the entrance of elevator 500 is on the left side of body 11, if body 11 makes a turn toward the side of destination point Pd (the end point position) inside elevator 500, the front side of body 11 would collide with the entrance of the elevator, for example.

Therefore, when the direction of body 11 is to be changed at via point Pw, body 11 makes a turn in a direction moving the front side (that is, an example of the other side in the present disclosure, the side opposite to the side toward which the turn center is eccentric) of body 11 away from destination point Pd (the end point position). In this manner, it is possible to prevent a situation in which the front end of body 11 delineating an arc comes into contact with wall surface 501, where the entrance of elevator 500 is provided.

Note that if via point Pw is relatively distant from the entrance of elevator 500, as illustrated in FIG. 7B, it would be possible to ensure a space for body 11 to make a turn in a direction in which the front side of body 11 is moved closer to the entrance of elevator 500 at via point Pw. However, if via point Pw is relatively distant from the entrance of elevator 500, the route of movement (approach route) along section 01 also passes through positions relatively distant from wall surface 501 where the entrance of elevator 500 is provided, and therefore, it would be more likely to interfere the movements of other people in elevator hall 600.

For this reason, it is preferable for the approach route in section 01 to take a route following wall surface 501 near wall surface 501, as described above. It is also preferable to turn body 11 in a direction in which the front side of body 11 moves away from destination point Pd, in the same manner as in FIG. 7A. When departure point Ps is at a position distant from wall surface 501 where the entrance of elevator 500 is provided, route determination unit 153 may set the approach route in such a manner that body 11 moves toward wall surface 501 once, and then moves to via point Pw along wall surface 501.

As described above, through this operation of turning the front side of body 11 in the direction away from destination point Pd, the rear side of body 11 is moved to the side facing destination point Pd provided inside elevator 500. In this orientation, route determination unit 153 determines the route for moving from the starting point position (via point Pw) to the end point position (destination point Pd) by using the second route determination method (see step S8 in FIG. 4). In the present disclosure, the route for moving from via point Pw outside elevator 500 to destination point Pd inside elevator 500, that is, the route for boarding elevator 500 will be referred to as a boarding route.

The second route determination method will be now described in detail. In the second route determination method, route determination unit 153 determines the boarding route on the basis of the target point set by target point setting unit 155.

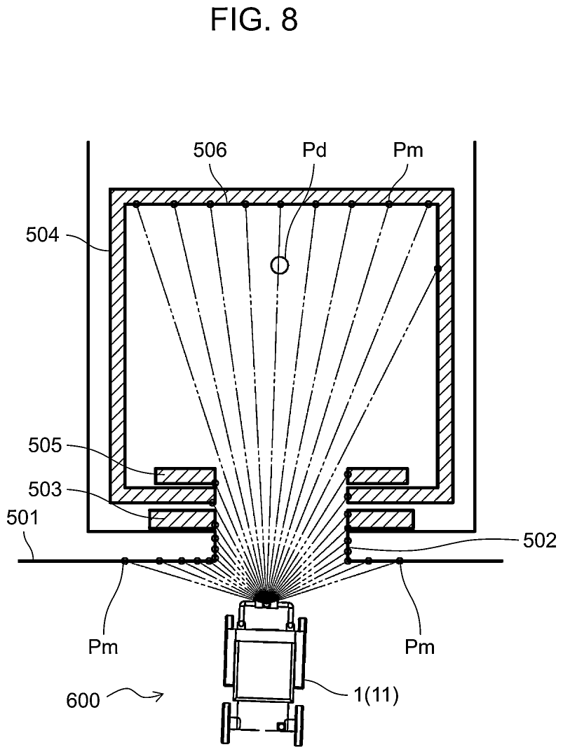

FIG. 8 is a diagram for describing a method by which target point setting unit 155 sets a target point.

A plurality of detection points Pm illustrated in FIG. 8 are detection points detected by ranging sensor 14B. When autonomous mobile object 1 is located at via point Pw, the detection points detected by ranging sensor 14B are detections of points on wall surface 501 where the entrance of elevator 500 is provided, door pocket 502 provided inside wall surface 501, outside door 503 of elevator 500, car 504, inside door 505 of elevator 500 and inside of car 504 including rear wall surface 506 of car 504 in the elevator.

Target point setting unit 155 extracts detection point group PmG_1 and detection point group PmG_2 from detection points Pm. Detection point group PmG_1 corresponds to wall surface 506 on the rear side of the car of elevator 500, and detection point group PmG_2 corresponds to the left and the right ends of the entrance of elevator 500.

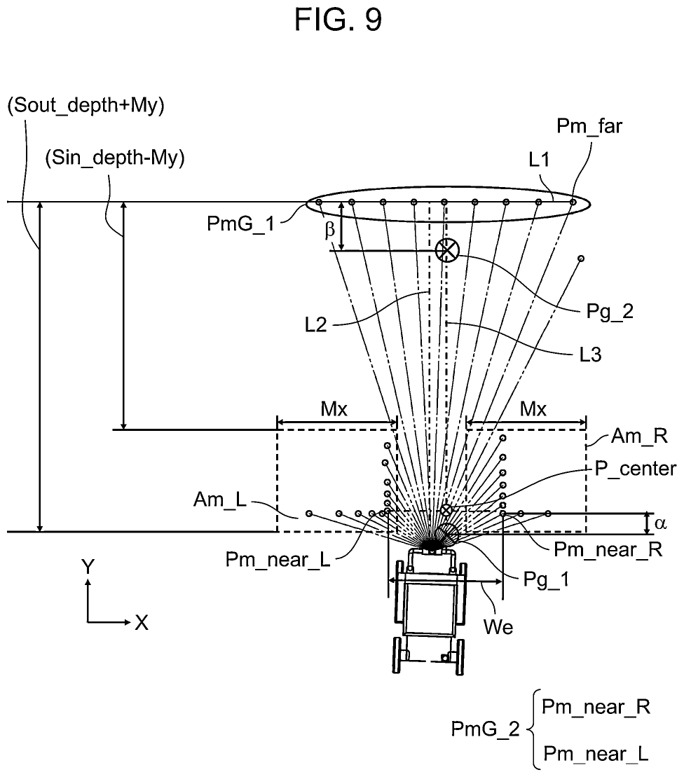

FIG. 9 is a diagram illustrating positional relationships between autonomous mobile object 1 and a plurality of detection points. FIG. 9 is a diagram with elevator 500 and the wall surface removed from FIG. 8.

To begin with, target point setting unit 155 extracts detection point Pm_far that is the point farthest away from body 11, from the group of the detection points detected by ranging sensor 14B. Target point setting unit 155 then extracts detection point group PmG_1 that are within a threshold distance from the farthest detection point Pm_far. Detection point group PmG_1 can be considered as a detection point group indicating rear wall surface 506 of the car of elevator 500.

Target point setting unit 155 then calculates line segment LI by a least squares estimation method or like, using the detection points belonging to detection point group PmG_1. Line segment L1 is a line segment corresponding to rear wall surface 506 of the car of elevator 500, in a top view of elevator 500 and autonomous mobile object 1.

Target point setting unit 155 also sets left detection area Am_L and right detection area Am_R for identifying the left end and the right of the entrance of elevator 500, respectively, on the basis of the shape information of elevator 500 stored in advance in shape information storage unit 151C. Target point setting unit 155 then extracts detection point Pm_near_L that is nearest to body 11, from the detection points in left detection area Am_L, and also extracts detection point Pm_near_R that is nearest to body 11, from the detection points in right detection area Am_R. The two detection points thus extracted correspond to the corners on the left and the right sides of the entrance of elevator 500, as illustrated in FIG. 9.

Left detection area Am_L and right detection area Am_R will now be described. For each of these detection areas, a range is set using various parameters indicating the shape of elevator 500 stored in shape information storage unit 151C.

For example, a range of the detection area in the depth direction of elevator 500 is set using inner depth size Sin_depth and outer depth size Sout_depth of the car of elevator 500, and their respective detection margins My. Range R_depth of the detection area in the depth direction is set to the range below in the depth direction, with reference to line segment L1, as illustrated in FIG. 9.

$$( Sin \_ depth - My ) < Rd \_ depth < ( Sout \_ depth + My )$$

A range of the detection area in the width direction of elevator 500 is set using entrance width We of elevator 500 and its detection margin Mx. Range R_width_L of the left detection area in the width direction is set to the range below in the width direction, with reference to perpendicular line L2 drawn from ranging sensor 14B to line segment L1, as illustrated in FIG. 9.

$$( - We / 2 - M x ) < R \_width \_ L < ( - We / 2 )$$

In the same manner, range R_width_R of the right detection area in the width direction is set to the range below in the width direction, with reference to perpendicular line L2 drawn from ranging sensor 14B to line segment L1.

$$( We / 2 ) < R \_width \_ R < ( We / 2 + Mx )$$

Left and right detection points Pm_near_L and Pm_near_R thus extracted are detection point group PmG_2 corresponding to the left and right ends of the entrance of elevator 500. Target point setting unit 155 derives center point P_center between detection points Pm_near_L and Pm_near_R. Target point setting unit 155 also draws perpendicular line L3 from center point P_center to line segment L1. Perpendicular line L3 is a straight line that passes through the center of the entrance of elevator 500, and that is perpendicular to rear wall surface 506 of the car of elevator 500.

Perpendicular line L3 thus derived passes through the entrance of elevator 500 and the center of the car of elevator 500. Therefore, by moving body 11 of autonomous mobile object 1 along perpendicular line L3, it is possible to reduce the possibility for body 11 coming into contact with the entrance, the door, the wall surface, and the like of elevator 500 even when the entrance of elevator 500 is relatively narrow.

Therefore, as illustrated in FIG. 9, target point setting unit 155 sets two target points Pg_1 and Pg_2 on perpendicular line L3 derived in the manner described above. First target point Pg_1 is plotted outside the entrance of elevator 500. Specifically, the position of target point Pg_1 is a point on perpendicular line L3 at distance a from center point P_center, in a direction toward outside of elevator 500.

Note that, as can be understood by making a reference to FIG. 9, center point P_center is the center point between the left and the right corners of the entrance of elevator 500 at the entrance of elevator 500. In other words, center point P_center is a center point between left detection point Pm_near_L and right detection point Pm_near_R that are on the outermost end of the entrance of elevator 500. Center point P_center is therefore located on the outermost side in a view from elevator 500. Hence, it is possible to obtain target point Pg_1 outside elevator 500 reliably, by setting target point Pg_1 at distance a from center point P_center in a direction toward the outside of elevator 500.

Second target point Pg_2 is plotted inside of the car of elevator 500 and near destination point Pd (within a predetermined distance). Specifically, target point Pg_2 is a position on perpendicular line L3, at distance β from line segment L1 corresponding to rear wall surface 506 of the car of elevator 500 toward the inside of elevator 500. Distances a and B are parameters determined based on the size of body 11, for example.

Route determination unit 153 determines the boarding route in a manner passing through the target point set in the manner described above by target point setting unit 155. Specifically, route determination unit 153 determines a boarding route in such a manner that body 11 is moved from via point Pw that is the starting point position of section 02 to target point Pg_2, via target point Pg_1.

As described above, target point Pg_1 and target point Pg_2 are on perpendicular line L3 passing through the center of the entrance of elevator 500. Therefore, by using a route causing body 11 to move to target point Pg_1 and then moved to target point Pg_2 inside elevator 500, it is possible to reduce the possibility of body 11 coming into contact with the entrance or the like of elevator 500.

Note that movement controller 152 may cause body 11 to move from the via point Pw to target point Pg_1, then cause body 11 to make a turn in the direction in which the rear side of body 11 faces to the side of target point Pg_2, and then cause body 11 to move to target point Pg_2.

As described above, target point Pg_2 is provided near destination point Pd on perpendicular line L3. Movement controller 152 may therefore determine that body 11 has reached destination point Pd, which is the end point position of section 02, at the timing when body 11 arrives at target point Pg_2, and end causing body 11 to stop. Alternatively, movement controller 152 may cause body 11 to move to target point Pg_2, and then cause body 11 to further move to destination point Pd. Note that destination point Pd or target point Pg_2 is a position inside elevator 500 at which body 11 does not come into contact with wall surface 506 inside elevator 500.

As described above, in the second route determination method, unlike the first route determination method, the boarding route is determined using the detection points on the parts of elevator 500 detected by ranging sensor 14B, without using the self-position estimated by position estimation unit 154 and the map information. The self-position estimated by position estimation unit 154 includes some errors, which may be resultant of errors in map information or in the encoder having measured the rotation speed of driving wheels 12, for example. Such errors are not of a particular issue in determining the approach route, which is the route for moving outside elevator 500, but more accurate route determination is required when autonomous mobile object goes through the entrance, and into elevator 500. In the second route determination method, because the boarding route is set without using information including errors such as errors in the map information, it is possible to determine the route at a higher accuracy than the first route determination method.

### Modifications

Described in the above exemplary embodiment is an example in which autonomous mobile object 1 makes a turn about turn center Cw that is the center point between the left and right driving wheels 12, by driving the left and right driving wheels 12 in opposite directions at the same speed to turn body 11. However, in the present disclosure, for example, it is also possible for body 11 to make a turn about one of the left and right driving wheels 12 as the turn center, by driving the other one of the left and right driving wheels 12 while keeping the one undriven.

Described in the above exemplary embodiment is a specific example in which autonomous mobile object 1 moves continuously along section 01, in which autonomous mobile object 1 moves from departure point Ps plotted in elevator hall 600 to via point Pw, and section 02, in which autonomous mobile object 1 moves from via point Pw to destination point Pd plotted inside elevator 500, continuously. However, in the present disclosure, the autonomous mobile object may move across three or more sections continuously.

In the above exemplary embodiment, an example in which autonomous mobile object 1 moves to destination point Pd that is inside elevator 500 has been described. The present disclosure is, however, also applicable to a situation in which the autonomous mobile object moves from a departure point inside the elevator to a destination point outside of the elevator. In such a case, when the autonomous mobile object leaves inside of the elevator to the elevator hall, the body may change the direction so that the front side faces the destination point, and move from that point to the destination point.

In the above exemplary embodiment, the rear wheels of autonomous mobile object 1 are driving wheels 12. However, in the present disclosure, the front wheels of the autonomous mobile object may be the driving wheels. In this case, the turn center of the autonomous mobile object is eccentrically set toward the front side of the machine body. When such an autonomous mobile object changes its direction so as to face a destination point plotted inside the via point elevator near the elevator entrance, the body may make a turn in a turning direction toward which the rear side of the body moves away from the destination point.

### INDUSTRIAL APPLICABILITY

The autonomous mobile object according to the present disclosure can make autonomous movements including boarding and unboarding elevator.

### REFERENCE MARKS IN THE DRAWINGS

1: autonomous mobile object
11: body
12: driving wheel
13: driven wheel
14, 14A, 14B: ranging sensor
15: controller
151: storage
151A: map information storage unit
151B: section information storage unit
151C: shape information storage unit
152: movement controller
153: route determination unit
154: position estimation unit
155: target point setting unit

1. An autonomous mobile object control method for controlling a driving unit that causes a body to move, the autonomous mobile object control method comprising:
a first step of determining an approach route that is a route to be followed by the autonomous mobile object to a starting point outside an elevator, and of moving the body by controlling the driving unit based on the approach route; and
a second step of determining a boarding route that is a route to be followed by the autonomous mobile object from the starting point to an end point inside the elevator, and of moving the body by controlling the driving unit based on the boarding route.

2. The autonomous mobile object control method according to claim 1, further comprising a third step of causing the body to make a turn at the starting point, about a turn center that is a point eccentric toward one side of the body, the turn being a turn in a direction moving another side of the body away from the end point, by controlling the driving unit,
wherein the third step is performed between the first step and the second step.

3. The autonomous mobile object control method according to claim 2, wherein
the starting point is first position information included in map information that includes a position of the elevator, and
in the first step, execution of the second step is determined based on the first position information.

4. The autonomous mobile object control method according to claim 2, wherein
the starting point is a position indicated by first position information included in map information that includes a position of the elevator, and
in the first step, execution of the third step is determined based on the first position information.

5. The autonomous mobile object control method according to claim 3, wherein
the autonomous mobile object includes a position estimation unit that estimates a position of the body, and
in the first step, the approach route is determined based on the map information and the position of the body, the position being estimated by the position estimation unit.

6. The autonomous mobile object control method according to claim 1, wherein
the autonomous mobile object includes a ranging sensor that measures a relative distance and direction between an object around the body and the body, and
in the second step, a relative position between the body and each part of the elevator is obtained based on a measurement result of the ranging sensor, and the boarding route is determined based on the relative position.

7. The autonomous mobile object control method according to claim 6, wherein, in the second step, the end point is set based on relative positions of the body, and both ends of an entrance of the elevator, and a rear wall of a car of the elevator with a door of the elevator opened.

8. The autonomous mobile object control method according to claim 7, wherein, in the second step, the end point is set on a perpendicular line passing through a center between the both ends of the entrance, and extending to the rear wall.

9. The autonomous mobile object control method according to claim 8, wherein, in the second step, by setting a via point on the perpendicular line outside the elevator, from the center between the both ends, and setting the end point on the perpendicular line inside a car of the elevator, the boarding route for moving the body from the starting point to the end point via the via point is generated.

10. The autonomous mobile object control method according to claim 9, wherein, in the second step, the via point is set at a position separated by a predetermined distance from the center between corners of the entrance, outside the elevator.
